(19) United States
(12) Patent Application Publication
(10) Pub. No.: US 2008/0039163 A1
(43) Pub. Date: Feb. 14, 2008

(54) SYSTEM FOR PROVIDING A PERSONALIZED COMIC STRIP

(75) Inventors: Antti Eronen, Tampere (FI); Jukka Holm, Tampere (FI); Arto Lehtiniemi, Lempaala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION, Espoo (FI)

(21) Appl. No.: 11/427,361

(22) Filed: Jun. 29, 2006

(51) Int. Cl. A63F 13/00; A63F 9/24; G06F 19/00; G06F 17/00

(52) U.S. Cl. 463/1

(57) ABSTRACT

An apparatus, method, computer program product, network entity and system are provided for providing a personalized comic strip, or cartoon. In particular, a mobile device collects information relating to an individual operating the mobile device (i.e., user-related information) from various sources associated with the mobile device. The mobile device may then transmit at least a subset of the information collected to a Personalized Comics Delivery Server, which uses the user-related information received to select, from a plurality of existing comic strips accessible by the server, a comic strip that seems appropriate for the user given his or her current situation. The Personalized Comics Delivery Server transmits the selected comic strip to the mobile device which, before displaying the comic strip to the user, modifies one or more parameters of the comic strip in order to further personalize it.

### FIELD

Exemplary embodiments of the present invention relate, generally, to comics and, in particular, to electronic provisioning of personalized comic strips.

### BACKGROUND

Comics, also referred to as “sequential art,” generally refers to a visual art made up of a one or more of images combined with text in order to convey a story or message. Some argue that the origin of comics can be traced back to Egyptian hieroglyphs. However, while comics of the past were commonly used simply for entertainment and for providing amusing anecdotes and stories, modern day comics have been characterized as a literary medium having many subgenres.

A comic strip generally refers to one or more frames or panels, each including one or more images and text, for example, in the form of speech balloons or image captions. Comic strips are commonly found in newspapers (i.e., the funnies section) and magazines, such as the New Yorker, which is known for including highly politicized comic strips. Comic books and albums are another form of comics that are available. Unlike newspapers or magazines where the comic strips constitute only a fraction of the content of the newspaper or magazine, comic books are generally made up almost solely of the string of frames or panels.

Hundreds of different comic strips exist throughout the world including, for example, Adam, Baldo, In the Bleachers, Big Top, Blondie, Bloom County, Boonducks, Calvin & Hobbes, Cathy, Cleats, Clear Blue Water, Close to Home, Cornered, Dilbert, Dennis the Menace, Doonsebury, Duplex, The Farside, Foxtrot, Fusco Brothers, Garfield, La Cucaracha, Lucky Cow, Marvin, Non Sequitur, Overboard, Peanuts, Pooch Café, PreTeena, Real Life Adventures, Stone Soup, Tank McNamara and Ziggy, just to name a few. In addition to being included in newspapers and magazines, these comic strips are also often available for downloading in electronic form to an individual's mobile device (e.g., cellular telephone, personal digital assistant (PDA), laptop, etc.).

While there are multitudes of comic strips available with which individuals can amuse themselves, it is likely that an individual will not be able to personally relate to any of the comic strips he or she reads in the newspaper or magazine, or downloads to his or her mobile device. A need, therefore, exists for a way to personalize existing comic strips available to individuals.

### BRIEF SUMMARY

In general, exemplary embodiments of the present invention provide an improvement over the known prior art by, among other things, providing a Personalized Comics Delivery Service. In particular, exemplary embodiments provide a technique for using information that is related to, and often specific to, a particular user of a mobile device (i.e., user-related information), to select a comic strip, or cartoon, that is appropriate for the user given his or her current situation. In one exemplary embodiment, the comic strip, or cartoon, may be made up of one or more frames or panels, each including one or more images and text, for example, in the form of speech balloons or image captions. Examples of user-related information may include where the user is currently located, who the user has most recently called or emailed, what individuals are located in the vicinity of the user, what is on the user's agenda for the day or week, what songs or albums the user has most recently listened to or downloaded, or what national or religious holiday is or is about to occur. Once selected, exemplary embodiments may modify the selected comic strip, or cartoon, based on the user-related information in order to further personalize the comic strip, or cartoon. This may include, for example, changing the name or appearance of the characters of the comic strip, or cartoon, selected, changing the text (e.g., the speech balloons) associated with one or more frames or panels, and/or modifying the background image.

In accordance with one aspect, an apparatus is provided. In one exemplary embodiment, the apparatus comprises: (1) an input for receiving a comic strip; (2) a processing element for modifying the comic strip received based at least in part on user-related information in order to produce a personalized comic strip; and (3) an output for displaying the personalized comic strip.

In accordance with another aspect, a method is provided. In one exemplary embodiment, the method includes: (1) receiving a comic strip; (2) modifying the comic strip received based at least in part on user-related information in order to produce a personalized comic strip; and (3) displaying the personalized comic strip.

In accordance with yet another aspect, a computer program product is provided. The computer program product contains at least one computer-readable storage medium having computer-readable program code portions stored therein. The computer-readable program code portions of one exemplary embodiment include: (1) a first executable portion for receiving a comic strip; (2) a second executable portion for modifying the comic strip received based at least in part on user-related information in order to produce a personalized comic strip; and (3) a third executable portion for displaying the personalized comic strip.

According to another aspect, a network entity is provided. In one exemplary embodiment, the network entity includes a processor and a memory in communication with the processor that stores an application executable by the processor, wherein the application is configured, upon execution, to: (1) receive a request for a personalized comic strip, wherein the request includes user-related information associated with a party requesting the personalized comic strip; (2) select a comic strip from a plurality of comic strips accessible by the network entity based at least in part on the user-related information; and (3) transmit the comic strip selected.

In accordance with yet another aspect, a system is provided. In one exemplary embodiment, the system includes: (1) a network entity; and (2) a mobile device in communication with the network entity for the purpose of receiving a comic strip. In one exemplary embodiment, the mobile device is configured to modify the comic strip received based at least in part on user-related information associated with a party operating the mobile device, and to display the modified comic strip to the party.

### BRIEF DESCRIPTION OF THE SEVERAL VIEWS OF THE DRAWING(S)

Having thus described exemplary embodiments of the invention in general terms, reference will now be made to the accompanying drawings, which are not necessarily drawn to scale, and wherein:

FIG. 1 is a flow chart illustrating the steps which may be taken in order to provide a personalized comic strip in accordance with exemplary embodiments of the present invention;

FIG. 2 is a block diagram of one type of system that would benefit from exemplary embodiments of the present invention;

FIG. 3 is a schematic block diagram of an entity capable of operating as a Personalized Comics Delivery Server in accordance with exemplary embodiments of the present invention; and

FIG. 4 is a schematic block diagram of a mobile station, or device, capable of operating in accordance with an exemplary embodiment of the present invention.

### DETAILED DESCRIPTION

Exemplary embodiments of the present invention now will be described more fully hereinafter with reference to the accompanying drawings, in which some, but not all embodiments of the inventions are shown. Indeed, exemplary embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, exemplary embodiments of the present invention provide an apparatus, method, computer program product, network entity and system for providing a personalized comic strip, or cartoon. In one exemplary embodiment, a mobile device (e.g., cellular telephone, PDA, laptop, etc.) collects information relating to an individual operating the mobile device (i.e., user-related information) from various sources associated with the mobile device. These sources may include, for example, a calendar, phonebook/contact and/or media rendering application operating on the mobile device, a Global Positioning System (GPS) receiver and/or one or more sensors located on the mobile device, and any number of other sources of user-related information located or operating on the mobile device. The mobile device may then transmit at least a subset of the information collected to a Personalized Comics Delivery Server, which uses the user-related information received to select, from a plurality of existing comic strips, or cartoons, accessible by the server (e.g., various Calvin & Hobbes and Doonesbury comic strips), a comic strip that seems appropriate for the user given his or her current situation. The Personalized Comics Delivery Server transmits the selected comic strip to the mobile device which, before displaying the comic strip to the user, modifies one or more parameters of the comic strip in order to further personalize it. The parameters modified may include, for example, the name and/or appearance of the characters, the text captions, the background image and/or the appearance of other objects in the comic strip.

### Method of Providing a Personalized Comic Strip

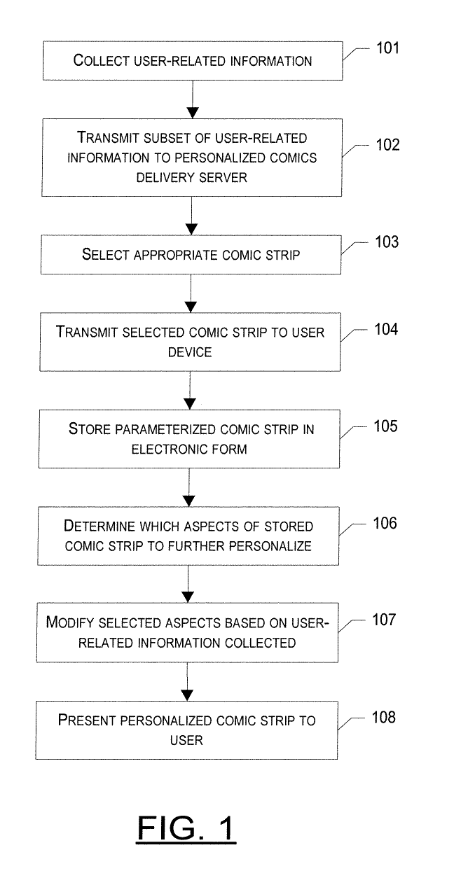

Reference is now made to FIG. 1, which illustrates the steps which may be taken in order to provide a personalized comic strip in accordance with one exemplary embodiment of the present invention. As shown the process begins at Step 101, where a comics personalization application operating on the user device (i.e., the mobile device operated by the user) collects information related to the user from various sources located or operating on the mobile device. The user-related information may include, for example, location information, context information, time and/or date information, information relating to media consumption, contact information, and/or other personal data input by the user, or party operating the mobile device, specifically for the purpose of receiving personalized comic strips.

Location information may be based, for example, on GPS data corresponding with the current location of the mobile device (i.e., latitude and longitude coordinates). The mobile device of one exemplary embodiment may, therefore, include a GPS or other location sensor for determining and providing this location information. In addition, location information may be based on one or more calendar entries of the mobile device calendar application. Examples of location information collected may include, in what city or state the user is currently located, or whether the user is, for example, at work, attending a seminar, on vacation, or at a baseball game.

Context information refers to any information which relates to the context associated with the user at a particular time. This information may be based, for example, on various sensors operating on the mobile device (e.g., illumination, temperature or noise sensors). An example of context information may include temperature information (i.e., whether it is currently cold or hot at the user's current location).

Time or date information may further be included in the user-related information collected and may include, for example, whether it is currently winter, spring, summer or fall, or whether it is a national or religious holiday. In one exemplary embodiment, this information may be collected using basic calendar information stored in the user's mobile device.

The user-related information may include information regarding the user's media consumption. In particular, the media consumption information may include, for example, the music files the user has recently listened to, downloaded or purchased using his or her mobile device. Similarly, it may include which movies or videos he or she has recently watched, downloaded or purchased, or which video games the user has recently played. In one exemplary embodiment, therefore, the mobile device may include one or more media rendering applications, as well as various hardware components necessary for listening to and/or viewing multimedia files.

Contact information, which may also make up at least a portion of the user-related information collected may be based, for example, on the user's phonebook application or contact list stored on his or her mobile device. The contact information may include, for example, the names of individuals the user has recently called or emailed, or to whom the user has recently sent a Short Message Service (SMS) or Multimedia Messaging Service (MMS) message. Finally, other personal data specifically entered and stored by the user may be included in the user-related information used to personalize the comic strips. In one exemplary embodiment, the user may have specifically stored information relating to, for example, his or her age, gender, occupation or hobbies, in association with the personalized comics delivery service or application, or some other application unrelated to the personalized comics delivery service.

Returning now to FIG. 1, the process continues to Step 102 where the client application transmits at least a subset of the user-related information collected to a Personalized Comics Delivery Server. The comics personalization application may do so automatically based on parameters established by the user. For example, the user may indicate that he or she would like to automatically receive a personalized comic strip each day, week or month. He or she may further specify the time of day at which the user would like to receive the comic strip (e.g., every morning at 7 a.m. when the user first wakes up and turns on his or her mobile device). Alternatively, or in addition, the comics personalization application may transmit the information to the Personalized Comics Delivery Server upon receiving specific instructions from the user to do so (i.e., in response to the user manually instructing the comics personalization application to provide a personalized comic strip). In one exemplary embodiment, the user may regularly, and automatically, receive a personalized comic strip, but upon arriving at an unusual place, or having a conversation with a person he or she has not spoken to in a long time, the user may desire to see what comic strip the service will generate based on the user's current situation. In this instance, the user may specifically instruct the mobile device to provide a comic strip, in addition to the usual comic strips he or she regularly receives.

In one exemplary embodiment, the comics personalization application may send all of the user-related data collected to the Personalized Comics Delivery Server. Alternatively, the comics personalization application may transmit only a subset of the data. Due to privacy concerns, the set of user-related information that is sent may be limited, for example, to place, time and media consumption-related information, in other words, information that people are generally already accustomed to providing to various services. Alternatively, in another exemplary embodiment, the user may select which user-related information may be sent to the Personalized Comics Delivery Server.

The Personalized Comics Delivery Server receiving the user-related information stores a plurality of comic strips (e.g., Calvin & Hobbes, Cathy, Doonesbury, Peanuts, etc.) that, in one exemplary embodiment, have been parameterized (i.e., defined in terms of various parameters, such as the characters, background images, text fields, and the like, wherein respective parameters are stored separately). In one exemplary embodiment, parameterization may occur automatically, wherein an application operating on the server applies edge detection and/or optical character recognition to segment, for example, characters and text from the comic strip. In another exemplary embodiment, parameterization may be performed manually, wherein an individual uses an image processing tool to, among other things, manually separate the character images and balloons from the background images of a comic strip received by the server and store the text appearing in the balloons in electronic form. In yet another alternative embodiment, parameterization may not be performed at all, whereby the server may store the plurality of comic strips as normal image files (i.e., without segmenting the various parameters). In this exemplary embodiment, an application operating on the mobile device or station may automatically analyze and parameterize the comic strips received. In a further exemplary embodiment, the server may additionally store metadata describing the content of each comic strip (e.g., “sports related,” “Christmas,” “work,” “anime,” “manga,” “babies,” etc.). In one exemplary embodiment, the addition of metadata to the comics strips stored is performed manually, for example, at the same time the comic strip is parameterized.

In one exemplary embodiment, the server may further store subscription or account information associated with the user. This may include, for example, a list of which comics the user prefers and/or dislikes. In particular, in one exemplary embodiment, the user may select a set of desirable comics and then specify the degree to which these comics (as opposed to new comics) should be included in the comics pushed to the mobile device. For example, the user may select ten of her favorite comics and specify that these ten comics should constitute 80% of the comic strips transmitted (or pushed) to the mobile device, while the remaining 20% may be selected by the server from all of the stored comics available. In addition, the user may indicate which comic genres and/or drawing styles he or she prefers (e.g., Disney, black-and-white, color, action, war, superheroes, animals, children, etc.). In an alternative embodiment, the user is not required to subscribe to the service, or provide account information to be stored by the Personalized Comics Delivery Server. In contrast, information regarding preferred or disliked comics may be stored by the mobile device and transmitted to the server along with, or as part of, the user-related information discussed above. In yet another embodiment, the user may provide a rating or vote to each comic strip he or she receives. The Personalized Comics Delivery Server may then keep track of these ratings and then use them when selecting comic strips to send. For example, where the user has consistently given a bad vote or rating to each Calvin & Hobbes comic strip he or she has received, the Personalized Comics Delivery Server may conclude that the user does not like Calvin & Hobbes and, therefore, stop sending those comic strips to the user.

Using the user-related information received, in Step 103, the Personalized Comics Delivery Server will select a comic strip that appears to be appropriate based on the user's current situation. The server may select a comic strip that relates to the user's current location or a location he or she has just visited. For example, where the user is traveling to Paris, the server may select a comic strip from the Asterix comics, the actions for which are set in France. The server may select a comic strip that is related to a particular national or religious holiday that is associated with the current day. If the user has been listening to a lot of music lately, or participating in or attending several sporting events lately, the server may select a comic strip that has to do with music or sports, respectively. If the user has been working a lot (based, for example, on calendar entries), the server may select a comic strip that has to do with the workplace. As noted above, the comic strip selected may be selected from a set of comics previously indicated by the user as preferable. Alternatively, or in addition, the server may avoid certain comics for which the user has indicated that he or she does not care.

Once the comic strip has been selected, in one exemplary embodiment, the Personalized Comics Delivery Server will transmit, or push, the comic strip to the mobile device. (Step 104). In particular, in one exemplary embodiment, the server will separately transmit the various parameters of the selected comic strip to the mobile device or station (i.e., assuming parameterization was either automatically or manually done on the server). Alternatively, where parameterization of the comic strip has not been done on the server, the server will transmit the comic strip as normal image file. In yet another alternative embodiment, not shown and which discussed in more detail below, the server will first personalize the comic strip prior to transmitting the personalized comic strip to the mobile station.

Assuming that the server merely transmits the selected comic strip to the mobile station (i.e., without further personalization) and that parameterization of the comic strip was previously done on the server, upon receipt, the mobile station of one exemplary embodiment, will then further personalize the comic strip based on all of the user-related information collected by the mobile station in Step 101. In particular, in Step 105, the mobile device will first store the parameterized comic strip in electronic form. As noted above, in one exemplary embodiment, parameterization of the comic strip may not have occurred on the server (i.e., the comic strip may not have been stored in parameterized electronic form on the server). In this exemplary embodiment, prior to storing the comic strip received, the mobile station may be required to first segment the various parameters (e.g., characters and/or text) of the comic strip.

Once the comic strip has now been parameterized, either on the server or by an application operating on the mobile device, certain parts of the comic strip are capable of being separately altered. In one exemplary embodiment, at least the following characteristics or aspects of the comic strip may be parameterized, either on the server or by the mobile station, and, therefore, are capable of being altered: the characters, the background images, and the text fields (i.e., text in balloons, text on buildings, text describing events (e.g., Crash!, BOOM!, etc.)).

After storing the parameterized comic strip, in Step 106, the mobile station will determine which of the parameters or aspects of the comic strip to personalize (i.e., will select the parameters of the comic strip to modify). These aspects may include, for example, portions of the text, background images, the appearance or names of the characters and/or the appearance of other objects (e.g., vehicles) in the comic strip. Finally, the mobile station will, in Step 107, modify the selected parameters based on the user-related information. For example, the mobile device may replace the background image of a comic strip received (which has been separated from a character image of the comic strip) and replace it with another image taken by the user, for example, from his or her vacation to Paris. The mobile device may then superimpose the character image onto the new background image in order to create a personalized comic strip. Similarly, in one exemplary embodiment, a character of the comic strip may have been segmented from the comic using image processing methods (either on the server or by the mobile station), and the mobile station may replace the character image with another image stored on or accessible by the mobile station. In addition, optical character recognition may be used to recognize a text field from a balloon, convert the field into text, analyze the field's content, and then replace some or all of the words or phrases with other words or phrases.

The following provides several examples of sources of information, which may be used when personalizing the comic strip and the modifications that may result.

### Contacts Book Enabled Personalization

In one exemplary embodiment, the names of the comics' characters may be replaced with names from the user's contacts book. For example, the names of the user's mom, dad, friends, boss, or the like, may replace the character names of the comic strip. To illustrate, the comic strip (or comics sequence) may have additional metadata describing the roles of the different characters in the comics, such as “a boss/director/manager.” This metadata can then be used to find a person with a title “director” or “manager” from the user's contacts book. Even if the comic strip does not have additional metadata, this information can often be obtained based on the text of the comic strip. For example, when the comic strip text reads “Manager Smith,” the personalized comics application operating on the mobile device may determine that “Smith” is the name of the manager character and replace Smith with the name of a manager or director found from the user's contacts book. In addition, in one exemplary embodiment, the pictures of persons in the user's contact book may be superimposed on the faces of corresponding comic strip characters.

As another example, the names of companies or corporations referenced in the comic strip may be modified. For example, if the comic strip text reads “Corporation Ltd.” or “Buzztech Corp.,” these company names may be replaced with company names found from the user's contacts book. In a similar manner, addresses associated with the companies may be changed.

### Bluetooth Neighborhood & Messaging

In one exemplary embodiment, the names of one or more users in a Bluetooth neighborhood (e.g. colleagues in the office) may also be used to replace the character names. Alternatively, or in addition, the names of one or more users who have recently been in an email discussion or phone call with the user can be used to replace the character names. In general, when character names are changed, a new name may be selected from the same gender than the original. However, it can also be very funny for the personalized comics application to mix genders.

### User Generated Content

In another exemplary embodiment, the most recent pictures taken by the user may replace, for example, the background images of the comic strip. In addition, the user may draw a picture of, or photograph, himself or herself, and this may be used to replace the face of a comic strip character that also receives the user's name. In one exemplary embodiment, the facial images drawn or photographed by the user may also be parameterized with respect to the eyes, eyebrows, and mouth, for example. This would allow also the expressions of the faces with replaced images to be modified. In particular, the user may, for example, indicate the location of the mouth, eyes and eyebrows in the image when he or she provides the image to the comics personalization application. When a comic strip character is, for example, angry, and the character's face has been replaced with a photograph, then the photograph may be modified to have an angry expression.

The images to be used as the characters' faces may also undergo certain processing before being used. For example, the picture of the user might be subjected to edge detection and other image processing operations, in order to obtain a caricature picture of the user that would better suit the style of the comics. For example, if the comic strip is black and white, the image will also be made black and white, whereas color images may be used in color comics.

### Location & Time

In yet another exemplary embodiment, the comic strip may appear differently depending upon where and when the comic strip is read. For example, if a certain location (e.g. a city or a country) is mentioned in the comic strip, the identification of the location may be changed, for example, according to the user's location, the location of a person the user has recently communicated with, or a location where the user has recently traveled. In addition, in one exemplary embodiment, the appearance of the characters may be adapted according to location. The characters may, for example, receive Turkish hats and moustaches if the user is in Turkey or just had a holiday there. In this exemplary embodiment, as noted above, the mobile device may include a GPS, or similar, location sensor that can be used to determine and provide the location information that is used to personalize the comic strip.

The time of the day may similarly affect the appearance of the characters, for example, by causing them to wear pajamas in the morning and the evening. In addition, special holidays (national or religious) may affect, for example, the background of the comic strip and/or the appearance of the characters. For example, during Christmas the background of a comic strip may have snow and Christmas trees, and characters may all have Christmas hats.

The weather may further affect the comic strip. In particular, the comic strip may be modified such that the weather in the comic strip reflects the weather the user is currently experiencing. Weather information may be obtained, for example, from web services by querying based on the user's current location.

In one exemplary embodiment, certain locations may provide “Comics hotspots,” where the users may receive comics related to the location. Examples might be buses or tourist attractions. For example, a bus may transmit a bus related comics to its passengers. The names of the characters in the comics may be adapted according to the contacts of the user. In Paris, for example, a user may receive a comic strip whose events take place at the Eiffel tower. Again, the names of the characters and their appearance can be adapted according to information on the user's terminal making the delivered comics much more personal.

### Sensors

In one exemplary embodiment, the mobile device may include one or more sensors, such as illumination, temperature, and noise sensors, operating thereon. The information sensed from the environment using these sensors may affect the comic strip. For example, in a loud noise the characters may receive earplugs. In a warm environment it may be sunny in the comics (i.e., a sun may be drawn into the background), and the characters may have less clothes and sunglasses. A cold environment may make the characters shiver and even add a textual comment about the cold weather.

### Media Consumption

In another exemplary embodiment, the types of media items a user is consuming and, therefore, presumably likes may affect the content of the comic strip. For example, if a music file is being played in the comic strip and the characters of the comic strip are discussing it, the name of the song may be taken, for example, as the last song the user was listening to. If the user is a fan of, for example, Metallica (as evidenced by the fact that the user has listened to Metallica recently), a Metallica shirt or metallica text may be added into the shirt of a character. Similarly, if the comic strip characters are discussing TV, the content may reflect the TV programs the user has recently watched or the programs that are currently on. For example, if a comic strip character asks “What's on TV,” the reply may be “The Bold and The Beautiful” if the time matches the time when the Bold and the Beautiful is being sent. Similarly, if the user has recently watched the TV series “24” about terrorists, the comics characters may obtain guns and one of them may be named Jack Bauer according to the “24” hero. As noted above, in these exemplary embodiment, the mobile device may include various media rendering applications, as well as one or more hardware components necessary for consuming various multimedia files.

Returning to FIG. 1, finally, once the comic strip has been personalized, in Step 108, the client application operating on the mobile device will present or display the personalized comic strip to the user.

In addition to the foregoing, in one exemplary embodiment, not shown, the user may specify a preferred music genre (e.g., classical, country, hard rock, reggae, etc.), and the comics personalization application may select music files, either stored on the mobile device or accessible via, for example, a music service provider, from that genre to play as background music while the user is consuming (i.e., viewing) the personalized comic strip. In addition, the comic strip itself may include certain music parameters (e.g., a preferred genre). Based on these parameters, the mobile device's comics personalization application may select music from the user's personal music collection. To illustrate, if the preferred genre for a comic strip is heavy metal, but the mobile device does not contain any heavy metal songs, some other genre that is as close as possible to the preferred genre may be selected (e.g., rock).

As noted above, while not shown, in one exemplary embodiment, the Personalized Comics Delivery Server, rather than the mobile device or station, may further personalize the comic strip based on user-related information and in the manner described above with respect to the mobile device, prior to transmitting the finalized comic strip to the mobile device. In this exemplary embodiment, the server may transmit the personalized comic strip as a plain image (i.e., not as separate parameters and without unnecessary metadata), and the mobile device may simply display the comic strip to the user without taking any further action. One advantage to having the server personalize the selected comic strip may be that the server has access to a much wider set of personalization content and rules than the mobile station.

### Overall System and Mobile Device:

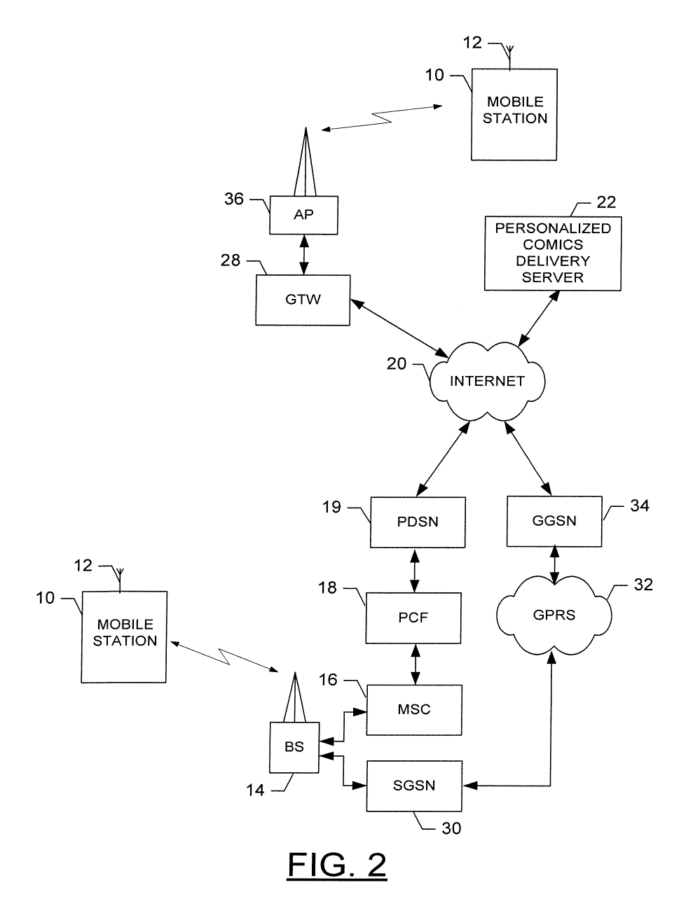

Referring to FIG. 2, an illustration of one type of system that would benefit from exemplary embodiments of the present invention is provided. As shown in FIG. 2, the system can include one or more mobile devices or mobile stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile station 10 via the Internet. For example, the processing elements can include a Personalized Comics Delivery Server 22, discussed below. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 (as well as one or more processing elements, although not shown as such in FIG. 2) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including Wireless LAN (WLAN) techniques. The APs may be coupled to the Internet 20. Like with the MSC 16, the AP's can be directly coupled to the Internet. In one embodiment, however, the APs are indirectly coupled to the Internet via a GTW 28. As will be appreciated, by directly or indirectly connecting the mobile stations and the processing elements (e.g., Personalized Comics Delivery Server 22) and/or any of a number of other devices to the Internet, whether via the AP's or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile stations 10 to one or more processing elements (e.g., a server associated with a Personalized Comics Delivery Service 22) across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques. Further, the mobile station 10 and the processing elements can be coupled to one or more electronic devices, such as printers, digital projectors and/or other multimedia capturing, producing and/or storing devices (e.g., other terminals).

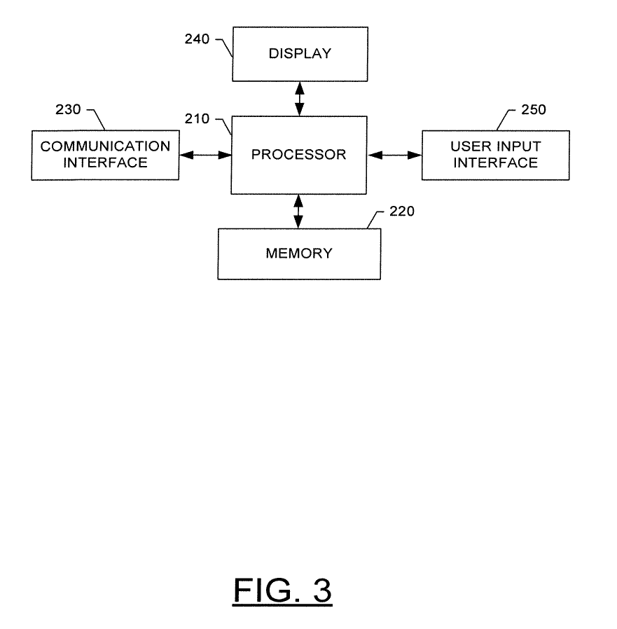

Referring now to FIG. 3, a block diagram of an entity capable of operating as a Personalized Comics Delivery Server 22 is shown in accordance with one embodiment of the present invention. The entity capable of operating as a Personalized Comics Delivery Server 22 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. As shown, the entity capable of operating as a Personalized Comics Delivery Server 22 can generally include means, such as a processor 210 connected to a memory 220, for performing or controlling the various functions of the entity. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

In particular, according to exemplary embodiments of the present invention, as discussed above, the memory 220 may store a plurality of parameterized comic strips along with metadata describing the content of each comic strip. The memory may further store a software application configured, upon execution by the processor 210, to receive a request for a comic strip that includes user-related information associated with the requestor, and to select, from the plurality of comic strips stored in memory (or otherwise accessible by the server) a comic strip that is appropriate based on user-related information included in the request received. In one exemplary embodiment, the application may further be configured, upon execution, to modify certain parameters of the comic strip selected based on the user-related information, prior to transmitting the comic strip to the mobile device from which the request was received.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

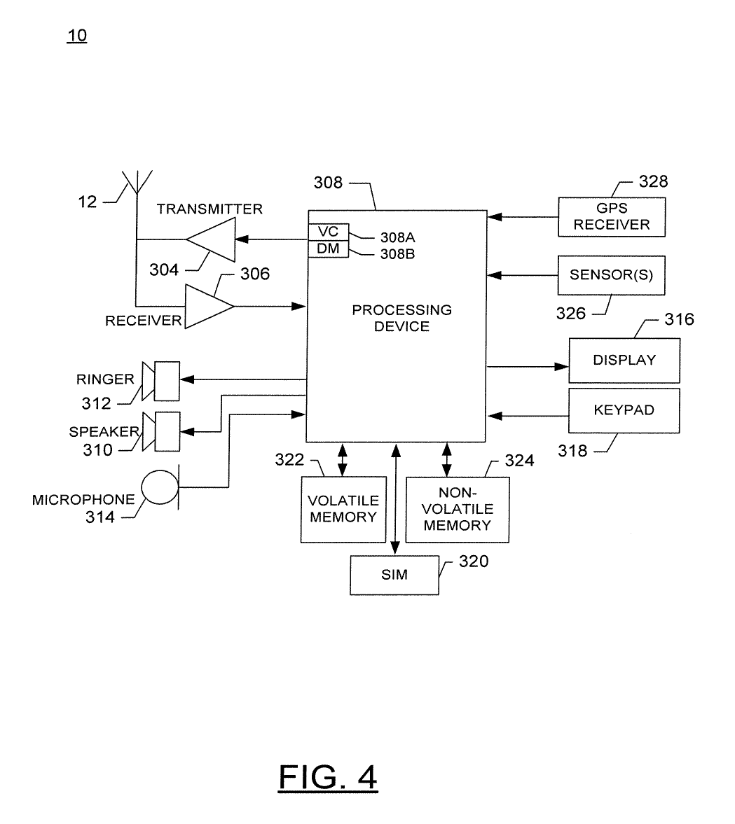

Reference is now made to FIG. 4, which illustrates one type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 4, in addition to an antenna 302, the mobile station 10 includes a transmitter 304, a receiver 306, and means, such as a processing device 308, e.g., a processor, controller or the like, that provides signals to and receives signals from the transmitter 304 and receiver 306, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 Wireless LAN (or Wi-Fi®), IEEE 802.16 WiMAX, ultra wideband (UWB), and the like.

It is understood that the processing device 308, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a touch display (not shown), a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs.

For example, in one embodiment of the present invention, the memory may store computer program code for performing Steps 101-102 and 105-108 of FIG. 1, discussed above (referred to as the comics personalization application). In particular, the memory may store computer program code at least for collecting user-related information, receiving a comic strip, modifying the comic strip based on the user-related information collected (e.g., by first storing the parameterized comic strip received and then modifying at least one of the parameters based on information associated with the user's current situation), and displaying the modified comic strip. The memory may further store one or more application from which the user-related information may be collected (e.g., a phonebook or similar contact application, a calendar application, a media rendering application, etc.). As noted above, the mobile station 10 may further comprise one or more sensors 326 (e.g., illumination, temperature and/or noise sensors), as well as a GPS receiver 328, which may further be used for collecting user-related information.

The apparatus, method, computer program product, network entity and system of exemplary embodiments of the present invention are primarily described in conjunction with mobile communications applications. It should be understood, however, that the apparatus, method, computer program product, network entity and system of embodiments of the present invention can be utilized in conjunction with a variety of other applications, both in the mobile communications industries and outside of the mobile communications industries. For example, the apparatus, method, computer program product, network entity and system of exemplary embodiments of the present invention can be utilized in conjunction with wireline and/or wireless network (e.g., Internet) applications.

### Conclusion:

As described above and as will be appreciated by one skilled in the art, embodiments of the present invention may be configured as an apparatus, method, network entity and system. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these exemplary embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
an input for receiving a comic strip;
a processing element for modifying the comic strip received based at least in part on user-related information to produce a personalized comic strip; and
an output for displaying the personalized comic strip.

2. The apparatus of claim 1, wherein the processing element collects the user-related information.

3. The apparatus of claim 2, wherein collecting the user-related information comprises collecting at least one of a calendar entry, a contact entry, a sensor output, or an identification of a media item consumed.

4. The apparatus of claim 1, wherein the processing element further transmits at least a subset of the user-related information to a network entity, in response to which the comic strip is received.

5. The apparatus of claim 1, wherein receiving a comic strip comprises receiving a parameterized comic strip.

6. The apparatus of claim 5, wherein the processing element further selects at least one parameter of the parameterized comic strip received to modify, such that modifying the comic strip received comprises modifying the parameter selected.

7. The apparatus of claim 6, wherein the at least one parameter is selected from the group consisting of a character image, a background image, a text field, or an object image.

8. A method comprising:
receiving a comic strip;
modifying the comic strip received based at least in part on user-related information to produce a personalized comic strip; and
displaying the personalized comic strip.

9. The method of claim 8 further comprising:
collecting the user-related information.

10. The method of claim 9, wherein collecting the user-related information comprises collecting at least one of a calendar entry, a contact entry, a sensor output, or an identification of a media item consumed.

11. The method of claim 8 further comprising:
transmitting at least a subset of the user-related information to a network entity, in response to which the comic strip is received.

12. The method of claim 8, wherein receiving a comic strip comprises separately receiving one or more parameters of the comic strip.

13. The method of claim 12 further comprising:
selecting at least one of the one or more parameters received to modify, wherein modifying the comic strip received comprises modifying the parameter selected.

14. The method of claim 13, wherein the at least one parameter is selected from the group consisting of a character image, a background image, a text field, or an object image.

15. A computer program product comprising at least one computer-readable storage medium having computer-readable program code portions stored therein, the computer-readable program code portions comprising:
a first executable portion for receiving a comic strip;
a second executable portion for modifying the comic strip received based at least in part on user-related information to produce a personalized comic strip; and
a third executable portion for displaying the personalized comic strip.

16. The computer program product of claim 15, wherein the computer-readable program code portions further comprise:
a fourth executable portion for collecting the user-related information.

17. The computer program product of claim 16, wherein the fourth executable portion is configured to collect at least one of a calendar entry, a contact entry, a sensor output, or an identification of a media item consumed.

18. The computer program product of claim 15, wherein the computer-readable program code portions further comprise:
a fourth executable portion for transmitting at least a subset of the user-related information to a network entity, in response to which the comic strip is received.

19. The computer program product of claim 15, wherein the first executable portion is configured to separately receive one or more parameters of the comic strip.

20. The computer program product of claim 19, wherein the computer-readable program code portions further comprise:
a fourth executable portion for selecting at least one of the one or more parameters received to modify, wherein the second executable portion is configured to modify the parameter selected.

21. The computer program product of claim 20, wherein the at least one parameter is selected from the group consisting of a character image, a background image, a text field, or an object image.

22. A network entity comprising:
a processor; and
a memory in communication with the processor, said memory storing an application executable by the processor, wherein the application is configured, upon execution, to:
receive a request for a personalized comic strip, said request comprising user-related information associated with a party requesting the personalized comic strip;
select a comic strip from a plurality of comic strips accessible by the network entity based at least in part on the user-related information; and
transmit the comic strip selected.

23. The network entity of claim 22, wherein the user-related information comprises at least one of a calendar entry, a contact entry, a sensor output, or an identification of a media item consumed.

24. The network entity of claim 22, wherein, in order to select a comic strip, the application is configured, upon execution, to:
access metadata associated with at least one comic strip of the plurality of comic strips accessible by the network entity.

25. The network entity of claim 22, wherein the application is further configured, upon execution, to:
access account information associated with the party requesting the personalized comic strip, said account information comprising some combination of an indication of one or more preferred comics, an indication of one or more disfavored comics, and an indication of a percentage of preferred comics to include in a pool of comics from which the comic strip may be selected.

26. The network entity of claim 22, wherein the application is further configured, upon execution, to:
prior to transmitting the comic strip selected, modify the comic strip selected based at least in part on the user-related information.

27. The network entity of claim 26, wherein, in order to modify the comic strip selected, the application is further configured, upon execution, to:
parameterize the comic strip selected; and
modify at least one parameter of the comic strip, wherein the at least one parameter is selected from the group consisting of a character image, a background image, a text field, or an object image.

28. The network entity of claim 22, wherein, in order to transmit the comic strip selected, the application is further configured, upon execution, to separately transmit one or more parameters of the comic strip selected.

29. A system comprising:
a network entity; and
a mobile device in communication with the network entity for the purpose of receiving a comic strip, said mobile device configured to modify the comic strip received based at least in part on user-related information associated with a party operating the mobile device to produce a personalized comic strip, said mobile device further configured to display the personalized comic strip to the party.

30. The system of claim 29, wherein the mobile device is further configured to collect the user-related information.

31. The system of claim 30, wherein, in order to collect the user-related information, the mobile device is configured to collect at least one of a calendar entry, a contact entry, a sensor output, or an identification of a media item consumed.

32. The system of claim 29, wherein the mobile device is further configured to transmit at least a subset of the user-related information to the network entity prior to receiving the comic strip.

33. The system of claim 32, wherein the mobile device is configured to automatically transmit at least a subset of the user-related information to the network entity on a periodic basis as defined by the party operating the mobile device.

34. The system of claim 32, wherein the mobile device is configured to transmit at least a subset of the user-related information to the network entity upon receiving an instruction from the party operating the mobile device to request a personalized comic strip.

35. The system of claim 32, wherein the network entity is configured to:
receive the at least a subset of the user-related information from the mobile device;
select a comic strip from a plurality of comic strips accessible by the network entity based at least in part on the at least a subset of the user-related information received; and
transmit the comic strip selected to the mobile device.

36. The system of claim 35, wherein, in order to select a comic strip, the network entity is further configured to access metadata associated with at least one comic strip of the plurality of comic strips accessible by the network entity.

37. The system of claim 36, wherein the network entity is further configured to:
access account information associated with the party requesting the personalized comic strip, said account information comprising some combination of an indication of one or more preferred comics, an indication of one or more disfavored comics, and an indication of a percentage of preferred comics to include in a pool of comics from which the comic strip may be selected.

38. The system of claim 35, wherein, in order to transmit the comic strip selected, the network entity is configured to separately transmit one or more parameters of the comic strip selected.

39. The system of claim 38, wherein the mobile device is further configured to:
select at least one of the one or more parameters received to modify, such that modifying the comic strip received comprises modifying the at least one parameter selected.

40. The system of claim 39, wherein the at least one parameter is selected from the group consisting of a character image, a background image, a text field, or an object image.

41. The system of claim 35, wherein the network entity is further configured to modify at least one parameter of the comic strip selected, based at least in part on the user-related information received, prior to transmitting the comic strip selected to the mobile device.
